(19) United States
(12) Patent Application Publication
(10) Pub. No.: US 2025/0126186 A1
(43) Pub. Date: Apr. 17, 2025

(54) METHODS AND APPARATUS TO MANAGE INFRASTRUCTURE AS CODE IMPLEMENTATIONS

(71) Applicant: VMware LLC, Palo Alto, CA (US)

(72) Inventors: Manish Jain, Faridabad (IN); Siddharth Sukumar Burle, Pune (IN); Vishal Gupta, Ludhiana (IN); Shivanee Shravan Bagbande, Pune (IN); Sagar Sheetalchandra Hukkeri, Pune (IN)

(21) Appl. No.: 18/651,419

(22) Filed: Apr. 30, 2024

(30) Foreign Application Priority Data
Oct. 15, 2023 (IN) 202341069398

(51) Int. Cl. H04L 67/60

(52) U.S. Cl. CPC H04L 67/60

(57) ABSTRACT

Methods and apparatus to manage infrastructure as code (IaC) implementations are disclosed, A disclosed example system to manage a shared computing resource includes programmable circuitry; and machine readable instructions to cause the programmable circuitry to: determine an IaC type associated with a request corresponding to the shared computing resource; select a template from a plurality of IaC templates based on the IaC type; and service the request based on the template.

### RELATED APPLICATIONS

This application claims priority to Indian Application No. 202341069398 filed Oct. 15, 2023, by VMware LLC, entitled “METHODS AND APPARATUS TO MANAGE INFRASTRUCTURE AS CODE IMPLEMENTATIONS,” which is hereby incorporated by reference in its entirety for all purposes.

### FIELD OF THE DISCLOSURE

This disclosure relates generally to distributed computing and, more particularly, to methods and apparatus to manage infrastructure as code implementations.

### BACKGROUND

In recent years, cloud-based systems have enabled distribution and scalability of computational services and/or resources. Particularly, microservice architectures utilized a cloud-based approach in which execution of a single application is composed of independently and/or discretely deployable smaller components or services referred to as microservices. Infrastructure as code (IaC) tools can be utilized to manage infrastructure operations of the computational services and/or resources of a cloud-based computing system. An IaC tool utilizes code instead of manual processes and can enable a wide degree of functionality, flexibility and customizability to manage a corresponding cloud-based computing system.

### BRIEF DESCRIPTION OF THE DRAWINGS

FIG. 1 is a block diagram of an example environment in which an example infrastructure as code (IaC) management device in accordance with teachings of this disclosure can be implemented.

FIG. 2 is an example process flow of the example IaC management device of FIG. 1.

FIGS. 3A and 3B depict another example process flow of the example IaC management device of FIG. 1.

FIG. 4 is another example process flow of the example IaC management device of FIG. 1.

FIG. 5 is another example process flow of the example IaC management device of FIG. 1.

FIG. 6 is a block diagram of an example IaC management system that can be implemented in accordance with examples disclosed herein.

FIGS. 7 and 8 are flowcharts representative of example machine readable instructions and/or example operations that may be executed, instantiated, and/or performed by example programmable circuitry to implement the IaC management system of FIG. 6.

FIG. 9 is a block diagram of an example processing platform including programmable circuitry structured to execute, instantiate, and/or perform the example machine readable instructions and/or perform the example operations of FIGS. 7 and 8 to implement the IaC management system of FIG. 6.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine readable instructions of FIGS. 7 and 8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Examples disclosed herein may be used to manage infrastructure as code (IaC) implementations. For shared computing resources, cloud-based services can be managed by an IaC implementation and/or tools. Currently, cloud-based services utilize tools such as Terraform, Ansible, Crossplane, Pulumi, AWS, Azure Resource Manager (ARM), Chef/Puppet, etc. A client that utilizes an IaC implementation/tool can have a relatively large infrastructure and corresponding resources for the IaC implementation/tool due to the IaC implementation/tool having unique features, functionality and capabilities. Further, the clients can prefer a specific IaC implementation/tool based on their infrastructure, implemented customizations and/or customer needs, for example.

Examples disclosed herein enable support for a plurality of different IAC implementations/tools by enabling provisioning thereof. Accordingly, examples disclosed herein leverage advantages of the different IaC implementations/tools to manage and automate a computing infrastructure, such as a cloud-based system with multiple different clients. Examples disclosed herein can enable provisioning, configuration, updates and maintenance with a wide variety of IaC implementations/tools. Examples disclosed herein can enable utilization of a wide array of custom plugins that are already available for these IaC implementations/tools, thereby reducing development costs and increasing capabilities and flexibility of an overall computing system. As a result, examples disclosed herein enable IaC implementations/tools that can be more effective for a particular project or task.

Examples disclosed herein can improve consistency of operations with multiple IaC implementations/tools by ensuring consistency across different parts of an infrastructure, as well as reducing a risk of misconfiguration or inconsistent data. Examples disclosed herein can also enable increased scalability such that multiple IaC implementations/tools can facilitate scaling of infrastructure to accommodate growing demands, as well as changing requirements. Examples disclosed herein can enable improved collaboration such that multiple IaC implementations/tools can enable improved collaboration amongst different teams and stakeholders by providing a standardized methodology for defining, deploying, and managing infrastructure. Examples disclosed herein can streamline deployment by automating infrastructure deployment and management, such that multiple IaC implementations/tools can reduce time and effort typically necessitated to deploy and maintain infrastructure.

Examples disclosed herein can effectively manage and utilize multiple different IaC implementations/tools with the use of templates that correspond to the different IaC implementations/tools. Examples disclosed herein utilize a template corresponding to each different IaC implementation/tool. In other words, examples disclosed herein can manage a plurality of IaC implementations/tools in a unified and/or integral interface to leverage capabilities of different IaC tools/services in a manner that is relatively transparent to a user/administrator.

Examples disclosed herein can receive and/or access a request (e.g., a request for a state change, a request to execute an IaC runtime, etc.) for a shared computing resource. In turn, examples disclosed herein can determine an IaC type and/or implementation corresponding (e.g., IDEM, Terraform, Ansible, etc.) to the request. Accordingly, examples disclosed herein select a template (e.g., a collection of rules and/or policies) from a plurality of IaC templates based on the determined IaC type. The template can be selected in conjunction with parameters, metadata and/or user credentials. In turn, examples disclosed herein can perform the aforementioned request with and/or based on the selected template (e.g., execute a runtime based on the IaC type and/or the selected template in conjunction with the template). Examples disclosed herein can also manage and/or integrate different IaC types and/or templates into an IaC service. In particular, examples disclosed herein can provision, configure and/or setup an IaC type and/or a template associated for each utilized IaC implementation/tool. Examples disclosed herein can also manage the templates associated with the plurality of IaC implementations/tools (e.g., the templates are updated, replaced, added, removed, etc.).

In some examples, the request corresponds to a state change request and/or an IaC task/command/runtime corresponding to the shared computing resource. In some examples, the request is validated and/or authenticated (e.g., based on user/administrator credentials, based on user metadata, etc.). In some such examples, a non-compliant or out-of-band request can result in a previously utilized/applied template being reinstated and/or reassigned for use with respect to the shared computing resource. In some examples, the IaC type is determined and/or identified based on IaC code of the request (e.g., the IaC code is embedded and/or integrated with the request). Additionally or alternatively, a runtime of a corresponding IaC type is executed based on a determination of the IaC type.

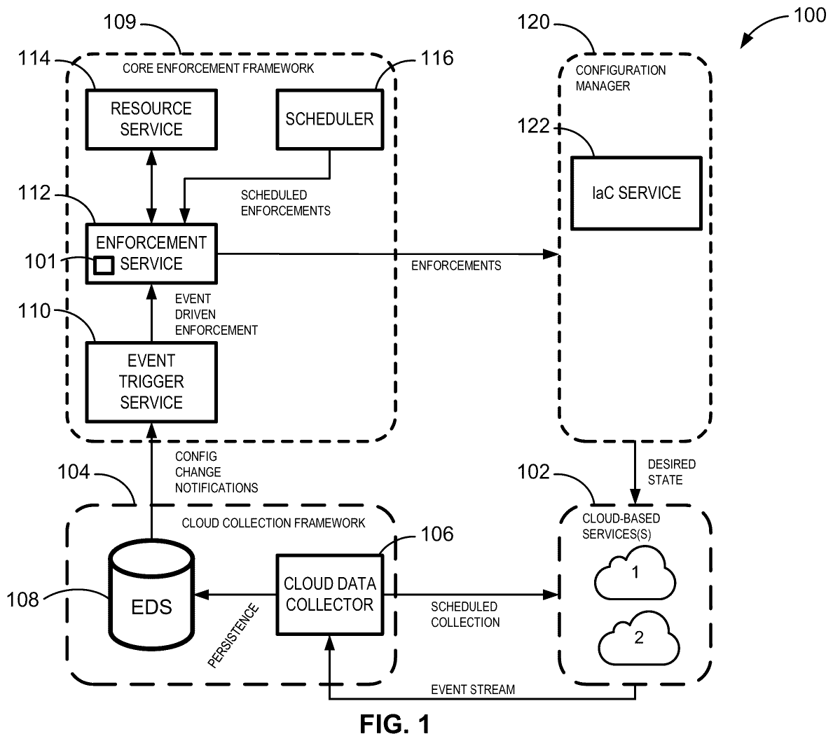

FIG. 1 is a schematic block diagram of an example environment 100 in which an example IaC management device 101 that operates to manage utilization of IaC instructions and/or requests of a distributed computing system can be implemented. In the illustrated example of FIG. 1, aspects and/or components of the environment 100 function as a system that manages operations and usage of at least one cloud-based service 102. The management of the operations can pertain to configuring settings, managing resource usage and/or managing access of the cloud-based service(s) 102. The example architecture shown in the example of FIG. 1 is only an example and any appropriate other architecture, network, control scheme, communication and/or data topology can be implemented instead.

According to examples disclosed herein, an example cloud collection framework 104 includes an example cloud data collector 106 to coordinate and communicate with the cloud-based service(s) 102. To that end, the example cloud data collector 106 can extract, receive and/or query information (e.g., components, metadata, services, service information) from the cloud-based service(s) 102. In this example, the cloud data collector 106 can request and/or direct the cloud-based service(s) 102 to provide information related to: (1) accounts utilizing the cloud-based service(s) 102, (2) at least one configuration of the cloud-based service(s) 102 and/or (3) services of the cloud-based service(s) 102. The request by the cloud data collector 106 to the cloud-based service(s) 102 can be driven by an occurrence of an event or performed on periodic or aperiodic timeframes and/or on a schedule. According to examples disclosed herein, the cloud-based service(s) 102 provide(s) data, requested changes, configuration information and/or updates associated with the cloud-based service(s) 102 to the cloud data collector 106 in response to a query from the cloud data collector 106 or without receiving a query from the cloud data collector 106. In some examples, the aforementioned data and/or updates provided to the cloud data collector 106 can include changes of a configuration of the cloud-based service(s) 102 and/or operational data of the cloud-based service(s) 102.

In this example, the aforementioned cloud collection framework 104 also includes an example entity data service (EDS) 108. The example EDS 108 can be implemented as a database, data store, database manager and/or database framework to store and/or collect data associated with the cloud-based service(s) 102. The example EDS 108 stores entity data of the cloud-based service(s) 102 in a normalized form (e.g., as a centralized repository). According to examples disclosed herein, the EDS 108 can provide any requested or proposed configuration change request to a core enforcement framework 109 which, in turn, includes an example event trigger service 110 that implements the aforementioned IaC management device 101, an example enforcement service 112, an example resource service 114 and an example scheduler 116. For example, when an event occurs, such as a rule change and/or a configuration change corresponding to the cloud-based service(s) 102, a notification from the EDS 108 is provided to the event trigger service 110.

The event trigger service 110 of the illustrated example is implemented to direct enforcement, configuration changes and/or access to services (e.g., microservices) of the cloud-based service(s) 102. The example event trigger service 110 can map a configuration change event to a desired state of the cloud service(s). Accordingly, the example event trigger service 110 can direct control, usage and/or configuration of the cloud-based service(s) 102 via (or in conjunction with) the aforementioned enforcement service 112. In this example, the event trigger service 110 provides requests and/or commands pertaining to event-driven enforcement of the cloud-based service(s) 102 to the enforcement service 112. In some examples, the event trigger service 110 manages and/or directs changes to key value data stores. In some examples, the event trigger service 110 can utilize and/or implement a Kubernetes cluster.

The example enforcement service 112 determines, manages and provides enforcements (e.g., configuration changes, access changes, resource usage instructions, a desired state change, etc.) with respect to the cloud-based service(s) 102 to a configuration manager 120 based on the event-driven enforcements and/or instructions received from the event trigger service 110. Additionally or alternatively, notifications (e.g., configuration change notifications), enforcements and/or instructions received from the resource service 114 and the scheduler 116 cause the enforcement service 112 to provide enforcements to the configuration manager 120. In turn, the enforcements provided to the configuration manager 120 are subsequently provided to the cloud-based service(s) 102 as desired state changes (e.g., desired state change instructions or directives).

In this example, the resource service 114 stores and/or manages operational data and/or settings of the cloud-based service(s) 102. In this example, the resource service 114 contains, analyzes and/or manages metadata of the cloud-based service(s) 102 that is utilized to manage the cloud-based service(s) 102. In particular, the metadata corresponds to settings, access information and/or configurations of the cloud-based service(s) 102, for example.

In some examples, the aforementioned scheduler 116 directs and/or manages scheduled implementations, configuration changes, enforcements and/or updates (e.g., periodic updates) of the cloud-based service(s) 102 via the example enforcement service 112 and the configuration manager 120. For example, the scheduler 116 can schedule the enforcement service 112 to perform scheduled enforcements of the configuration services 120 which, in turn, controls and/or directs a desired state of the cloud-based service(s) 102.

To control, manage, enforce and/or direct operation of the cloud-based service(s) 102, as mentioned above, the example enforcement service 112 provides the enforcements to the configuration manager 120. In this example, the configuration manager 120 includes an IaC service 122, which can implement an idempotent (IDEM) IaC implementation or any other appropriate type of IaC implementation (e.g., Terraform, Ansible, etc.). The configuration services associated with the configuration manager 120 and/or the IaC service 122 are distinct from the core enforcement framework 109 and, thus, the enforcement service 112. However, the IaC service 122 can be integrated with the enforcement service 112 and/or the core enforcement framework 109 in other examples. In the illustrated example of FIG. 1, the IaC service 122 is an implementation/provisioning engine that implements desired state changes with respect to the cloud-based service(s) 102. In other words, the IaC service 122 controls a desired state of the cloud-based service(s) 102 based on enforcements provided from the enforcement service 112. While the IaC management device 101 is shown implemented in the example event trigger service 110, additionally or alternatively, the IaC management device 101 can be implemented in the enforcement service 112, the resource service 114 and/or the scheduler 116.

As mentioned above, any appropriate data topology, architecture and/or structure can be implemented instead. Further, any of the aforementioned aspects and/or elements described in connection with FIG. 1 can be combined or separated as appropriate. Further, while examples disclosed herein are shown in the context of cloud services/computing resources, examples disclosed herein can be implemented in conjunction with any appropriate distributed and/or shared computing resource system.

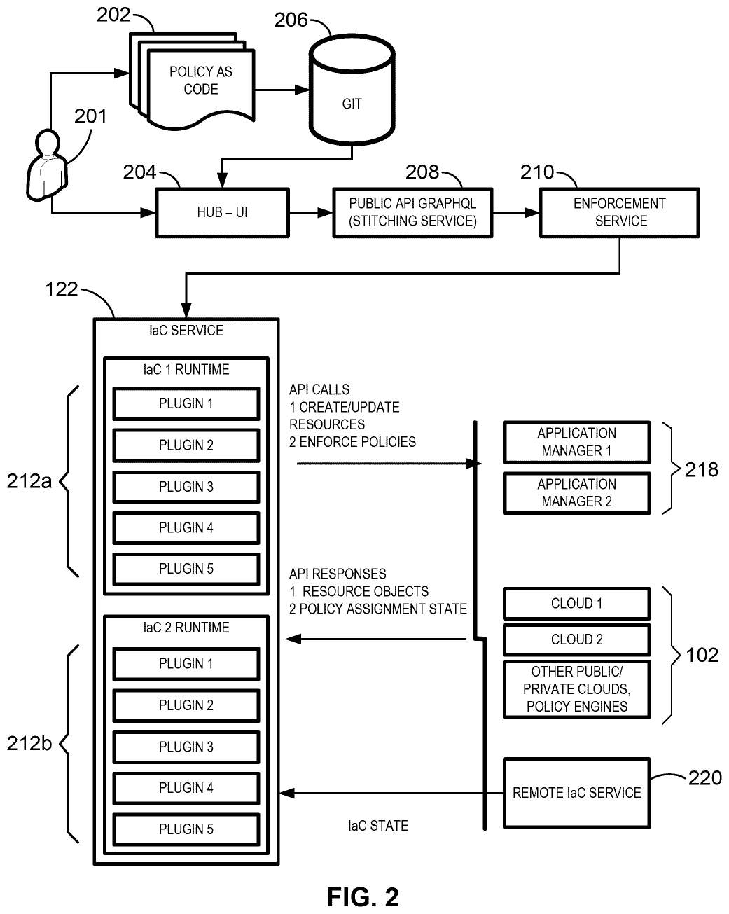

FIG. 2 is an example process flow of the example IaC management device 101 of FIG. 1. In the illustrated example of FIG. 2, The example process flow of FIG. 2 illustrates example utilization of an architecture to support multiple different IaC implementations/tools. In this example, a user (e.g., an administrator) 201 can issue a request for a state change or a configuration change of the cloud service(s) 102, for example, via a policy as code information/data 202, a git data storage 206, and/or a hub user interface (UI) 204. In turn, a public application programming interface (API) 208, which can be referred to as a stitching service, conveys the request to the enforcement service 210, which can be implemented as the core enforcement framework 109 and/or the enforcement service 112 shown in FIG. 1.

In example FIG. 2, based on the request received at the enforcement service 210, the IaC service 122 manages, controls and/or coordinates different IaC implementations/tools with corresponding plugins 212a, 212b. Examples disclosed herein can advantageously utilize functionality of the different plugins 212a, 212b per client demand/needs. The example plugins 212a, 212b can be customized plugins that are suited for a multitude or variety of tasks. The tasks may include, but are not limited to, management, compliance, feature implementation, monitoring, etc.

To manage operation of the cloud service(s) and/or application manager(s) 218 corresponding to the cloud service(s) 102 in conjunction with multiple different IaC implementations/tools, the IaC service 122 provides and/or issues requests to create resources, update resources, configure resources and/or enforce policies to at least one of application managers 218, and/or cloud service(s) 102 based on instructions from the enforcement service 210. In turn, an example remote IaC service 220 returns and/or conveys resource objects and/or information/data corresponding to a policy/assignment state of the cloud-based service(s) 102. As can be seen in the illustrated example of FIG. 2, the enforcement service 210 supports and facilitates utilization of multiple different IaC implementations/tools. In other words, examples disclosed herein provide a framework that can support multiple IaC implementations/tools and, thus, can provide a relatively large amount of flexibility while leveraging different features and advantages spanning across the different IaC implementations/tools.

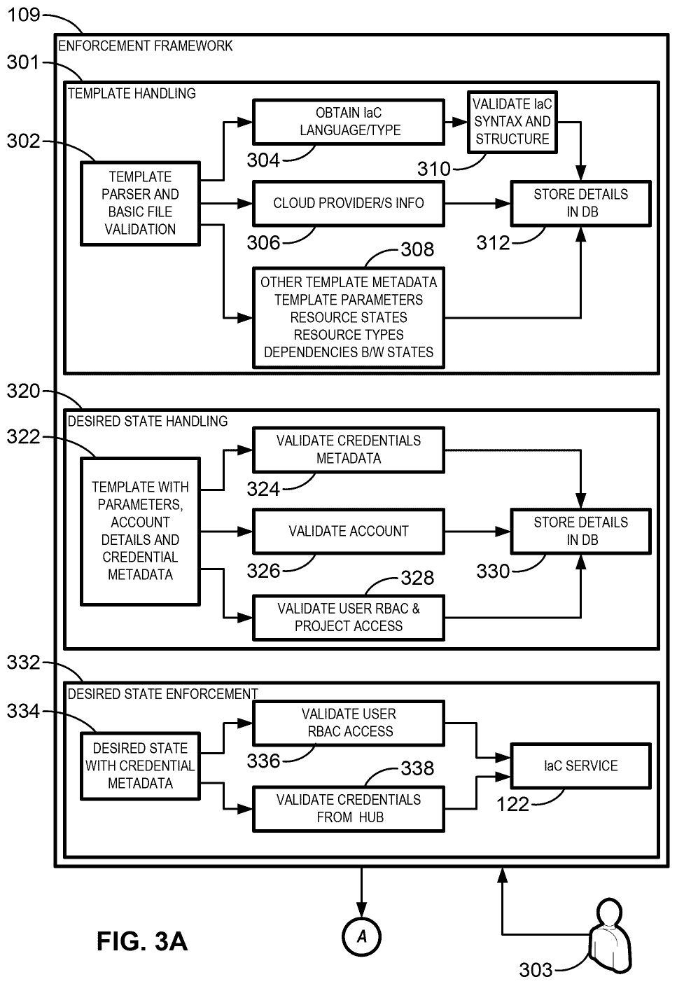

FIGS. 3A and 3B depict another example process flow of the example IaC management device 101 associated with the enforcement framework 109 of FIG. 1. Turning to example FIG. 3A, template handling 301 is performed to implement and/or integrate an IaC implementation/tool. In this example, at block 302, an IaC template provided by a user 303 is parsed and basic file validation is performed. At example block 304, the type and/or the language of the template is determined. At block 306, in some examples, cloud provider/operator information is determined and/or accessed. At example block 308, additionally or alternatively, other parameters and/or data are obtained including, but not limited to, other template metadata, template parameters, resource states, resource types, dependencies, bandwidth states, etc. At example block 310, IaC syntax and/or structure is validated. At example block 312, details of the template are stored in a database.

Example desired state handling 320 of the cloud service(s) 102 is performed to configure and/or direct operation of the multiple IaC implementations/tools utilized for operation with the cloud service(s) 102. At block 322, a template with parameters, account details and/or credential data (e.g., credential metadata) is provided. At block 324, the credentials data is validated. At block 326, account details are validated (e.g., based on the aforementioned account details and/or credential data, based on credential metadata, etc.). At example block 328, user information, credentials and/or metadata is validated via role-based access control (RBAC) and, in turn, a desired state of the cloud service(s) 102 is defined and/or created at block 330.

In the illustrated example of FIG. 3A, enforcement 332 of a desired state of the cloud service(s) 102 is performed. At example block 334, a desired state (e.g., a desired state request) with credential metadata is provided. In this example, at block 336, the user RBAC is validated and, at example block 338, credentials from an interface hub (e.g., an Aria hub) are validated. As a result, the IaC service 122 is instructed and/or provided with the desired state.

FIG. 3B depicts example operation of the example configuration manager 120 and/or the IaC service 122 with multiple IaC implementations/tools with respect to the example of FIG. 3A described above. At example block 342, an IaC type is checked and/or determined in response to receiving a request. Accordingly at least one of the IaC runtimes 344, 346, 348 is to be executed and/or operated based on the determined IaC type. At example block 350, a credential is fetched form the interface hub mentioned above in connection with the enforcement 332 shown in FIG. 3A. At block 352, according to examples disclosed herein, the template is executed and/or utilized based on the request.

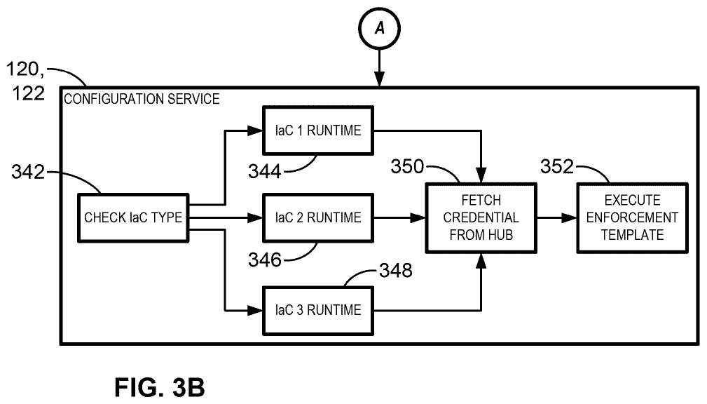

FIG. 4 is another example process flow of the example IaC management device 101 of FIG. 1. In this example, an unauthorized user 402 communicates with the cloud service(s) 102 such that the unauthorized user 402 provides an out-of-band request (e.g., an incorrect and/or unauthorized state change request) to the cloud service(s) 102. In turn, the cloud service(s) 102 convey information/data to public cloud resource collectors 404. In this example, the information/data corresponds to configuration change events from the cloud service(s) 102 and/or corresponding providers (e.g., service providers, operational managers, etc.) of the cloud service(s) 102.

Accordingly, the configuration change events are provided from the source collectors 404 to the EDS 108 and, subsequently, provided/forwarded to an ensemble event bus 406 which, in turn, forwards the configuration change events to the ETS 110, the core enforcement framework 109 and/or the enforcement service 112 shown in FIG. 1. In this example, the ETS 110 reenforces and/or returns the previous state of the cloud service(s) 102 for enforcement and/or maintenance of a desired state of the cloud service(s) 102.

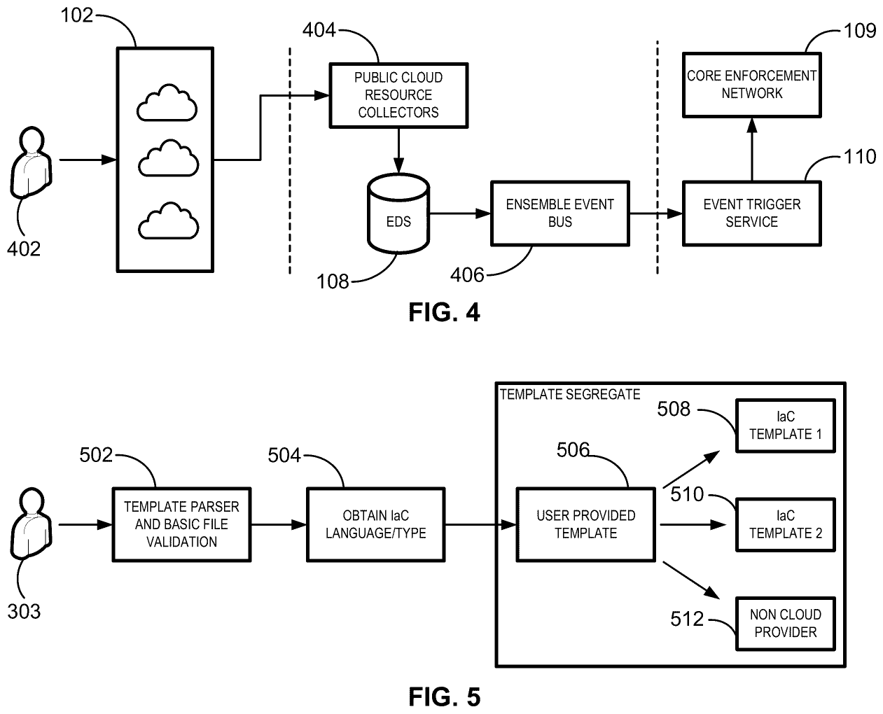

FIG. 5 is another example process flow of the example IaC management device 101 of FIG. 1. In the illustrated example, the user 303 provides a request such that the request is parsed and validated, at block 502. The aforementioned request may include a template and/or a designation of a template to be used. In this example, at block 504, the IaC language and/or type of the request is determined and/or obtained. At block 506, the template associated with the request is segregated and/or grouped between either a first IaC template 508, a second IaC template 510 or a template 512 of a non-cloud provider.

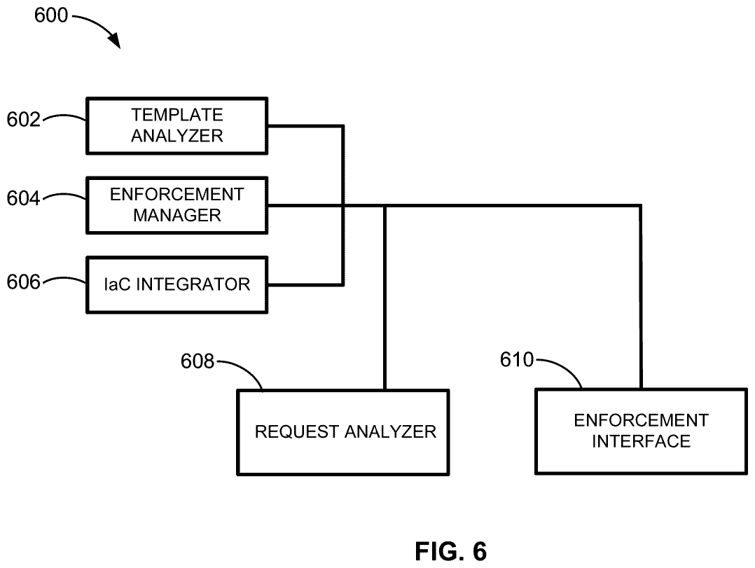

FIG. 6 is a block diagram of an example implementation of an example IaC management system 600 to manage multiple IaC implementations. The example IaC management system 600 can be implemented on the enforcement service 112 and/or the configuration manager 120. The example IaC management system 600 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the example IaC management system 600 of FIG. 6 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers.

The IaC management system 600 of the illustrated example includes an example template analyzer 602, an example enforcement manager 604, an example IaC integrator 606, and an example request analyzer 608. According to examples disclosed herein, the IaC management system 600 is communicatively coupled to and/or includes example enforcement interface 610 to receive requests corresponding to the cloud service(s) 102 shown in FIG. 1.

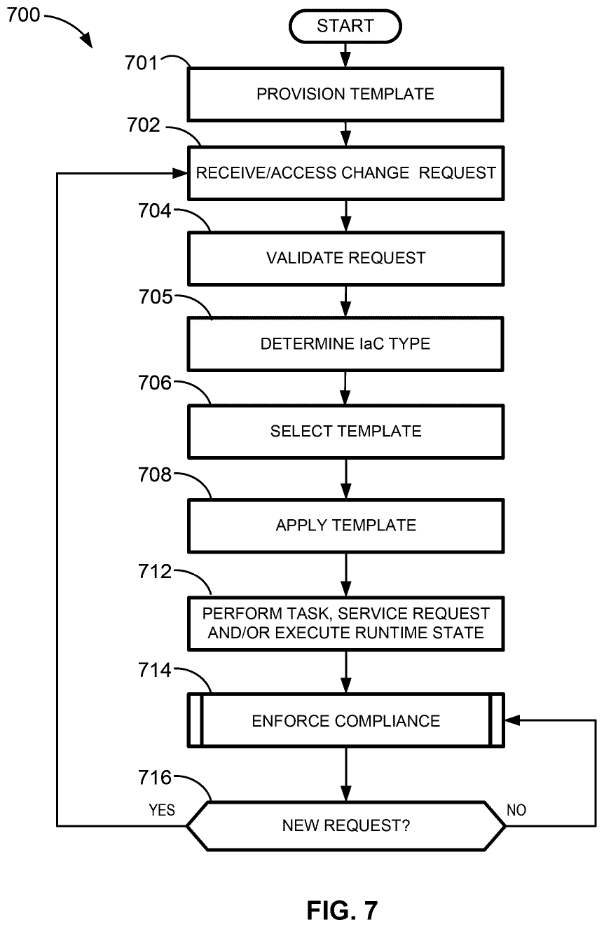

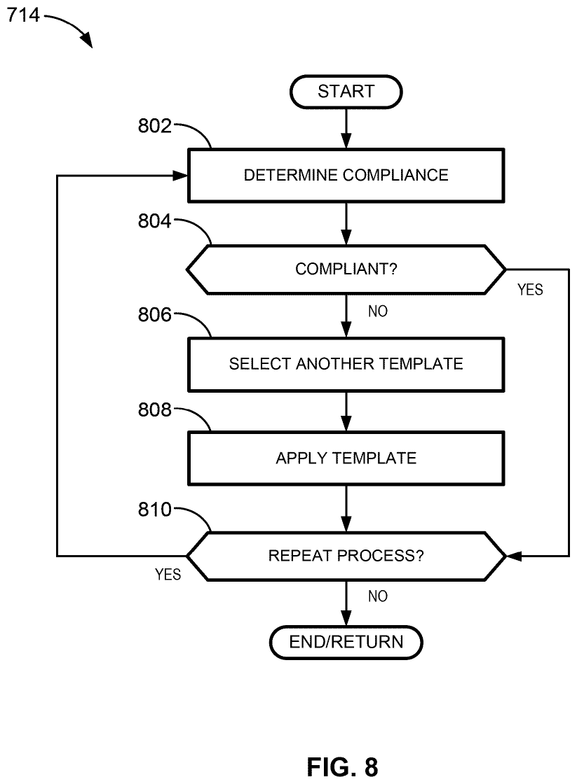

In the illustrated example of FIG. 6, the template analyzer 602 determines an IaC language and/or type corresponding to a request (e.g., a state change request, a configuration change request, etc.). According to some examples disclosed herein, the template analyzer 602 of the illustrated example determines an IaC type, protocol and/or implementation. Additionally or alternatively, a syntax and/or structure of the request is determined and/or characterized. According to some examples disclosed herein, the template analyzer 602 can select an IaC template to be utilized to execute the request with a corresponding IaC architecture and/or implementation. In some examples, the template analyzer 602 is instantiated by programmable circuitry executing template analyzer instructions and/or configured to perform operations such as those represented by the flowcharts of FIGS. 7 and 8.

The example enforcement manager 604 enables and/or directs a state change of the cloud service(s) 102 based on the request. In the illustrated example, the enforcement manager 604 utilizes the template selected by the template analyzer 602 for the state change such that the template is appropriate and/or compatible with an IaC type associated with the request. In some examples, the enforcement manager 604 is instantiated by programmable circuitry executing enforcement manager instructions and/or configured to perform operations such as those represented by the flowcharts of FIGS. 7 and 8.

In some examples, the IaC integrator 606 is implemented to provision and/or configure an IaC template in the configuration manager 120. In some such examples, the IaC integrator 606 receives a template corresponding to an IaC type and stores the same for subsequent utilization of the IaC type on the cloud service(s) 102. In a particular example, the IaC integrator 606 parses and validates the template for usage. In some examples, the IaC integrator 606 is instantiated by programmable circuitry executing IaC integrator instructions and/or configured to perform operations such as those represented by the flowcharts of FIGS. 7 and 8.

In some examples, the request analyzer 608 receives/accesses requests corresponding to the cloud service(s) 102. In some such examples, the request analyzer 608 is implemented to receive, access and/or accept requests. Additionally or alternatively, the request analyzer 608 is utilized to authenticate a user and/or an IaC request to change and/or configure a state of the cloud service(s) 102. In some examples, the request analyzer 608 is instantiated by programmable circuitry executing request analyzer instructions and/or configured to perform operations such as those represented by the flowcharts of FIGS. 7 and 8.

In the illustrated example of FIG. 6, the enforcement interface 610 provides state change requests and/or instructions to the cloud service(s) 102. Additionally or alternatively, the enforcement interface 610 provides updates and/or status information of a state of the cloud service(s) 102. In some examples, the enforcement interface 610 is instantiated by programmable circuitry executing enforcement interface instructions and/or configured to perform operations such as those represented by the flowcharts of FIGS. 7 and 8.

While an example manner of implementing the IaC management system 600 of FIG. 1 is illustrated in FIG. 6, one or more of the elements, processes, and/or devices illustrated in FIG. 6 may be combined, divided, re-arranged, omitted, eliminated, and/or implemented in any other way. Further, the example template analyzer circuitry 602, the example enforcement manager 604, the example IaC integrator 606, the example request analyzer 608, the example enforcement interface 610, and/or, more generally, the example IaC management system 600 of FIG. 6, may be implemented by hardware alone or by hardware in combination with software and/or firmware. Thus, for example, any of the example template analyzer circuitry 602, the example enforcement manager 604, the example IaC integrator 606, the example request analyzer 608, the example enforcement interface 610, and/or, more generally, the example IaC management system 600, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs to implement corresponding ones of template analyzer circuitry, enforcement manager circuitry, IaC integrator circuitry, request analyzer circuitry, and/or enforcement interface circuitry. Further still, the example IaC management system 600 of FIG. 6 may include one or more elements, processes, and/or devices in addition to, or instead of, those illustrated in FIG. 6, and/or may include more than one of any or all of the illustrated elements, processes and devices.

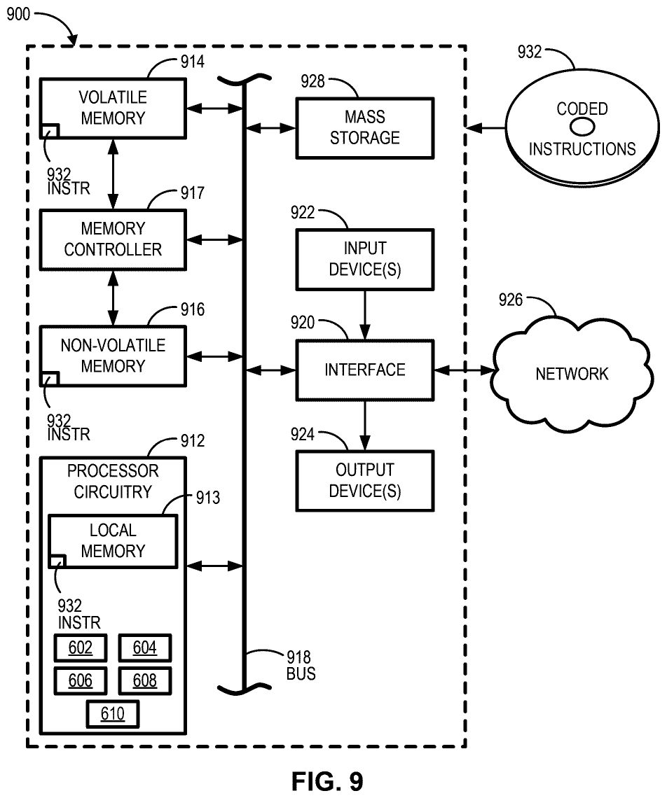

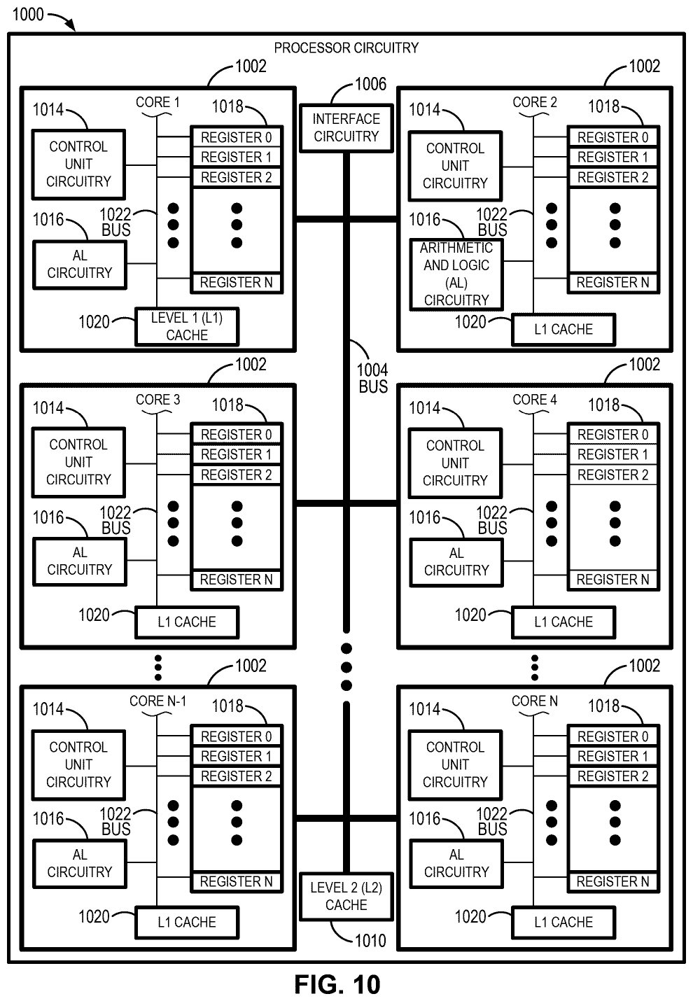

Flowcharts representative of example machine readable instructions, which may be executed by programmable circuitry to implement and/or instantiate the IaC management system 600 of FIG. 6 and/or representative of example operations which may be performed by programmable circuitry to implement and/or instantiate the IaC management system 600 of FIG. 6, are shown in FIGS. 7 and 8. The machine readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program(s) and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program(s) is/are described with reference to the flowcharts illustrated in FIGS. 7 and 8, many other methods of implementing the example IaC management system 600 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7 and 8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine readable instructions and/or example operations 700 that may be executed, instantiated, and/or performed by programmable circuitry to manage operation of the cloud service(s) 102 via multiple IaC implementations/tools utilized thereon. The example machine-readable instructions and/or the example operations 700 of FIG. 7 begin at block 701, at which the example IaC integrator 606 and/or the example template analyzer 602 configures and/or establishes templates corresponding to multiple different IaC types/implementations. In particular, the templates can correspond to different IaC architectures, runtimes, languages, protocols, standards, functions and/or implementations, etc.

At block 702, the example enforcement interface 610 receives/accesses a request corresponding to the cloud service(s) 102. In this example, the request includes a state change request corresponding to the cloud service(s) 102. Additionally or alternatively, the request corresponds to a request to execute a runtime (e.g., an IaC runtime).

At block 704, the enforcement manager 604 and/or the template analyzer 602 validates the request.

At block 705, the IaC integrator 606 of the illustrated example determines an IaC type, protocol and/or implementation corresponding to the request. According to some examples, the IaC integrator 606 determines an IaC type of code corresponding to the request (e.g., Idem IaC code is identified).

At block 706, the template analyzer 602 of the illustrated example selects the template. In this example, the template analyzer 602 selects the template (e.g., for use) based on the determined IaC type.

At block 708, in some examples, the example template analyzer 602 and/or the example enforcement manager 604 applies the selected template. For example, the example template analyzer 602 and/or the example enforcement manager 604 applies the template to the configuration manager 120 and/or the IaC service 122 to direct operations thereof (e.g., for compliance, enforcement, etc.). Additionally or alternatively, the example template analyzer 602 and/or the example enforcement manager 604 determines an IaC runtime to execute based on the selected template.

At block 712, the example enforcement manager 604 performs a task, executes a runtime (e.g., an IaC runtime, etc.) and/or services a request corresponding to and/or based on the template. According to examples disclosed herein, the enforcement manager 604 causes the runtime to be executed based on the IaC type determined and the selected template.

At block 714, the example enforcement manager 604 enforces compliance of the state of the cloud service(s) 102, as discussed in greater detail below in connection with FIG. 8.

At block 716, the example request analyzer 608 determines whether a new request has been received. If the new request has been received (block 716: YES), control of the process returns to block 702. Otherwise, the control returns to block 714.

FIG. 8 is a flowchart representative of example machine readable instructions and/or example operations 714 that may be executed, instantiated, and/or performed by programmable circuitry to control utilization of multiple IaC implementations and/or runtimes. The example instructions and/or operations may be used to implement block 715 of FIG. 7. The example machine-readable instructions and/or the example operations 714 of FIG. 8 begin at block 802, at which the example enforcement manager 604 checks and/or determines compliance of a state and/or a state change request corresponding to the cloud service(s) 102. In some examples, the enforcement manager 604 determines whether the state change request is out-of-band.

At block 804, the example enforcement manager 604 determines whether the state and/or the state request is compliant. If the state and/or the state request is compliant (block 804: YES), control proceeds to block 810. Otherwise, the control proceeds to block 806.

At block 806, the example enforcement manager 604 selects another template. In this example, the enforcement manager 604 switches back to the prior template based on information from the example template analyzer 602.

At block 808, the example enforcement manager circuitry 604 applies the template selected (e.g., previously selected prior to the state change) by the example template analyzer 602 to enforce operations of the configuration manager 120, the IaC service 122 and/or the cloud service(s) 102 (e.g., for enforcement, security, legal compliance, etc.). For example, the enforcement manager circuitry 604

At block 810, it is determined by the enforcement manager circuitry 604 whether to enforce compliance of another state of a cloud service. If the enforcement compliance process is to be repeated (block 810: YES), control returns to block 802. Otherwise, example instruction and/or operations 714 end and control returns to the instructions and/or operations 800 of FIG. 7.

FIG. 9 is a block diagram of an example programmable circuitry platform 900 structured to execute and/or instantiate the example machine-readable instructions and/or the example operations of FIGS. 7 and 8 to implement the IaC management system 600 of FIG. 6. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the example template analyzer 602, the example enforcement manager 604, the example IaC integrator circuitry 606, the example request analyzer 608, and the example enforcement interface 610.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 7 and 8, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 7 and 8 to effectively instantiate the circuitry of FIG. 6 as logic circuits to perform operations corresponding to those machine readable instructions. In some such examples, the circuitry of FIG. 6 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 7 and 8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

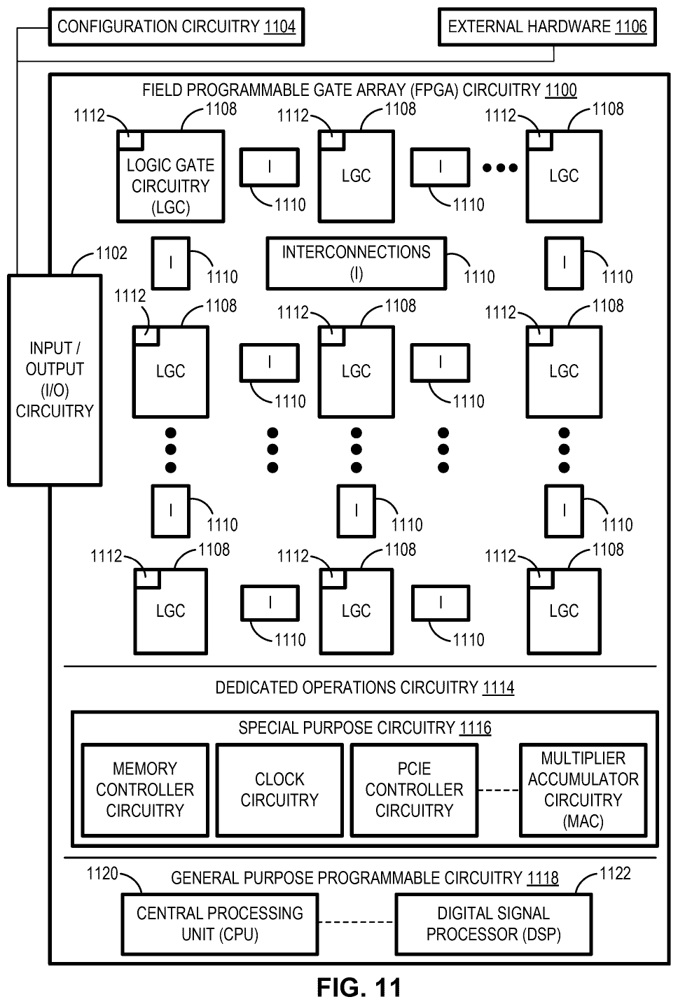

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 7 and 8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 7 and 8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 7 and 8. As such, the FPGA circuitry 1100 may be configured and/or structured to effectively instantiate some or all of the operations/functions corresponding to the machine readable instructions of the flowcharts of FIGS. 7 and 8 as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIGS. 7 and 8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIGS. 7 and 8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine readable instructions represented by the flowcharts of FIGS. 7 and 8 to perform first operation(s)/function(s), the FPGA circuitry 1100 of FIG. 11 may be configured and/or structured to perform second operation(s)/function(s) corresponding to a second portion of the machine readable instructions represented by the flowcharts of FIGS. 7 and 8, and/or an ASIC may be configured and/or structured to perform third operation(s)/function(s) corresponding to a third portion of the machine readable instructions represented by the flowcharts of FIGS. 7 and 8.

It should be understood that some or all of the circuitry of FIG. 6 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 6 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 6 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

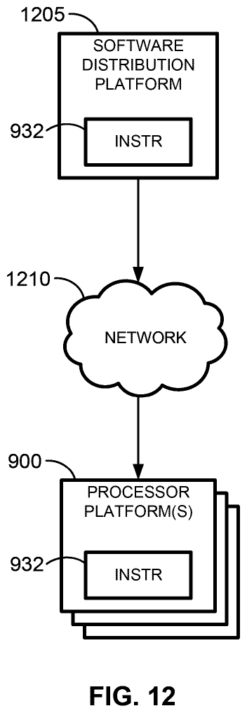

A block diagram illustrating an example software distribution platform 1205 to distribute software such as the example machine readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 7 and 8, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIGS. 7 and 8, may be downloaded to the example programmable circuitry platform 900, which is to execute the machine readable instructions 932 to implement the IaC management system 600. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices. Although referred to as software above, the distributed “software” could alternatively be firmware.

Example methods, apparatus, systems, and articles of manufacture to enable utilization, coordination, provisioning and/or integration of multiple different IaC types/tools/implementations are disclosed herein. Further examples and combinations thereof include the following:

Example 1 includes a system to manage a shared computing resource, the system comprising programmable circuitry, and machine readable instructions to cause the programmable circuitry to determine an infrastructure as code (IaC) type associated with a request corresponding to the shared computing resource, select a template from a plurality of IaC templates based on the IaC type, and service the request based on the template.

Example 2 includes the system as defined in example 1, wherein the request corresponds to a state change request of the shared computing resource.

Example 3 includes the system as defined in example 1, wherein the programmable circuitry is to execute a runtime of the shared computing resource corresponding to the IaC type.

Example 4 includes the system as defined in example 1, wherein the template is a first template and wherein the programmable circuitry is to determine that the request is out-of-band, and service the request based on a second template after the determination that the request is out-of-band, the second template different from the first template.

Example 5 includes the system as defined in example 4, wherein the second template is utilized prior to selecting the first template.

Example 6 includes the system as defined in example 1, wherein the request includes IaC code, and the programmable circuitry is to determine the IaC type based on the IaC code.

Example 7 includes the system as defined in example 1, wherein the programmable circuitry is to provision an IaC template into the plurality of IaC templates based on a type of the IaC template.

Example 8 includes a non-transitory machine readable storage medium comprising instructions to cause programmable circuitry to at least determine an infrastructure as code (IaC) type associated with a request corresponding to a shared computing resource, select a template from a plurality of IaC templates based on the IaC type, and service the request based on the template.

Example 9 includes the non-transitory machine readable storage medium as defined in example 8, wherein the request corresponds to a state change request of the shared computing resource.

Example 10 includes the non-transitory machine readable storage medium as defined in example 8, wherein the instructions are to cause the programmable circuitry to execute a runtime of the shared computing resource corresponding to the IaC type.

Example 11 includes the non-transitory machine readable storage medium as defined in example 8, wherein the template is a first template and wherein the instructions are to cause the programmable circuitry to determine that the request is out-of-band, and service the request based on a second template after the determination that the request is out-of-band, the second template different from the first template.

Example 12 includes the non-transitory machine readable storage medium as defined in example 11, wherein the second template is utilized prior to selecting the first template.

Example 13 includes the non-transitory machine readable storage medium as defined in example 8, wherein the request includes IaC code, and the instructions cause the programmable circuitry to determine the IaC type based on the IaC code.

Example 14 includes the non-transitory machine readable storage medium as defined in example 8, wherein the instructions are to cause the programmable circuitry to provision an IaC template into the plurality of IaC templates.

Example 15 includes a method comprising determining, by executing an instruction with programmable circuitry, an infrastructure as code (IaC) type associated with a request corresponding to a shared computing resource, selecting, by executing an instruction with the programmable circuitry, a template from a plurality of IaC templates based on the IaC type, and performing, by executing an instruction with the programmable circuitry, the request based on the template.

Example 16 includes the method as defined in example 15, further including executing a runtime of the shared computing resource corresponding to the IaC type.

Example 17 includes the method as defined in example 15, wherein the template is a first template and further including performing the request based on a second template after a determination that the request is out-of-band, the second template different from the first template.

Example 18 includes the method as defined in example 17, wherein the second template is utilized prior to selecting the first template.

Example 19 includes the method as defined in example 15, wherein the request includes IaC code, the method including determining the IaC type based on the IaC code.

Example 20 includes the method as defined in example 15, further including provisioning an IaC template into the plurality of IaC templates.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable utilization of multiple IaC implementations/tools and, thus, greater flexibility for users/operators. Disclosed systems, apparatus, articles of manufacture, and methods improve the efficiency of using a computing device by enabling integration of multiple IaC types/implementations in contrast to utilizing multiple systems for each IaC type/implementation, for example. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A system to manage a shared computing resource, the system comprising:
programmable circuitry; and
machine readable instructions to cause the programmable circuitry to:
determine an infrastructure as code (IaC) type associated with a request corresponding to the shared computing resource;
select a template from a plurality of IaC templates based on the IaC type; and
service the request based on the template.

2. The system as defined in claim 1, wherein the request corresponds to a state change request of the shared computing resource.

3. The system as defined in claim 1, wherein the programmable circuitry is to execute a runtime of the shared computing resource corresponding to the IaC type.

4. The system as defined in claim 1, wherein the template is a first template and wherein the programmable circuitry is to:
determine that the request is out-of-band; and
service the request based on a second template after the determination that the request is out-of-band, the second template different from the first template.

5. The system as defined in claim 4, wherein the second template is utilized prior to selecting the first template.

6. The system as defined in claim 1, wherein the request includes IaC code, and the programmable circuitry is to determine the IaC type based on the IaC code.

7. The system as defined in claim 1, wherein the programmable circuitry is to provision an IaC template into the plurality of IaC templates based on a type of the IaC template.

8. A non-transitory machine readable storage medium comprising instructions to cause a programmable circuitry to at least:
determine an infrastructure as code (IaC) type associated with a request corresponding to a shared computing resource;
select a template from a plurality of IaC templates based on the IaC type; and
service the request based on the template.

9. The non-transitory machine readable storage medium as defined in claim 8, wherein the request corresponds to a state change request of the shared computing resource.

10. The non-transitory machine readable storage medium as defined in claim 8, wherein the instructions are to cause the programmable circuitry to execute a runtime of the shared computing resource corresponding to the IaC type.

11. The non-transitory machine readable storage medium as defined in claim 8, wherein the template is a first template and wherein the instructions are to cause the programmable circuitry to:
determine that the request is out-of-band; and
service the request based on a second template after the determination that the request is out-of-band, the second template different from the first template.

12. The non-transitory machine readable storage medium as defined in claim 11, wherein the second template is utilized prior to selecting the first template.

13. The non-transitory machine readable storage medium as defined in claim 8, wherein the request includes IaC code, and the instructions cause the programmable circuitry to determine the IaC type based on the IaC code.

14. The non-transitory machine readable storage medium as defined in claim 8, wherein the instructions are to cause the programmable circuitry to provision an IaC template into the plurality of IaC templates.

15. A method comprising:
determining, by executing an instruction with programmable circuitry, an infrastructure as code (IaC) type associated with a request corresponding to a shared computing resource;
selecting, by executing an instruction with the programmable circuitry, a template from a plurality of IaC templates based on the IaC type; and
performing, by executing an instruction with the programmable circuitry, the request based on the template.

16. The method as defined in claim 15, further including executing a runtime of the shared computing resource corresponding to the IaC type.

17. The method as defined in claim 15, wherein the template is a first template and further including performing the request based on a second template after a determination that the request is out-of-band, the second template different from the first template.

18. The method as defined in claim 17, wherein the second template is utilized prior to selecting the first template.

19. The method as defined in claim 15, wherein the request includes IaC code, the method including determining the IaC type based on the IaC code.

20. The method as defined in claim 15, further including provisioning an IaC template into the plurality of IaC templates.
